(19) United States
(12) Patent Application Publication
(10) Pub. No.: US 2024/0321291 A1
(43) Pub. Date: Sep. 26, 2024

(54) SYSTEMS AND METHODS FOR PRESENTATION ANALYSIS AND SUPPORT

(71) Applicant: Ruben Dua, Valencia, CA (US)

(72) Inventor: Ruben Dua, Valencia, CA (US)

(21) Appl. No.: 18/126,151

(22) Filed: Mar. 24, 2023

(51) Int. Cl. G10L 25/60; G10L 15/08; G10L 25/57

(52) U.S. Cl. CPC G10L 25/60; G10L 15/08; G10L 25/57

(57) ABSTRACT

The invention is a system and method of use for distilling, grouping and quantifying words, by category, from those captured in a digitized video file. The invention can be used for analysis and refinement of idealized models of chosen words, cadence, and other spoken-language aspects that affect the effectiveness of a presentation.

### TECHNICAL FIELD

The invention system enables one to analyze a presentation, captured on video, for various characteristics that affect its effectiveness.

### BACKGROUND

Live and video presentations are used for conveying information to a chosen audience. The purpose may be to convey new information, to change opinions about existing information, to inspire, to help consummate an agreement, and the like.

A presentation comprises spoken words, visual aids, and body language. In attempting to analyze a presentation's effectiveness, one must decide what constitutes effectiveness, and what aspects of body language and speech need to be isolated and analyzed. To be sure, such analysis is soft science. Hand gestures, for example, may help emphasize a key point, but used to excess, they may detract from overall effectiveness. So, analysis not only comprises isolating various body-language and spoken-language elements, but also quantifying them to determine any degree of underuse or overuse.

As to whether a presentation was effective, in an ideal case, one would be able to sample a target audience's opinions about a selected list of points, and then see how that may have changed after a presentation. That may provide an overall sense of effectiveness. By capturing the body language and/or spoken language and analyzing it, one may then be able to correlate the various aspects of body language and spoken language with levels of presentation effectiveness.

Body language and spoken language are a rich palate of aspects such as hand motion, eye contact, loudness, pacing, use of visuals, and so on. Tools that allow capture and isolation of these aspects are an important factor in continued analysis and presentation-effectiveness improvement.

### SUMMARY OF THE INVENTION SYSTEM

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The invention system enables capturing of various spoken-language aspects, from an existing video of a presentation, and using various word categories, speech rates, word repetitions, and the like, to quantitatively analyze the spoken-language content of a presentation as a way to help gauge its effectiveness.

Using a video of an earlier presentation, the system filters out video data while preserving and conditioning audio data. The audio data is then passed through a speech-recognition portion of the system to extract recognized words. These recognized words are compared against a database of words and selected word categories.

A programmable processing subsystem then uses the tagged words and their categories to produce a report of such aspects as repetitions, use of jargon, use of profanity, and so on.

The end results of a presentation captured on video provides an important, quantitative, data set. Similar data sets can be aggregated to provide greater sampling depth. Ultimately, one goal is to develop a quasi-idealized model by collecting scores related to effectiveness and professionalism as provided through panels of experts and/or focus groups that represent target audiences.

In manufacturing, programs such as ISO provide guidelines for continuous improvements. In similar fashion, the invention becomes a key tool in analysis and continuous improvement of presentation effectiveness.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a presenter having his presentation captured by video system to produce a video file containing both visual and spoken digitized data, according to some embodiments;

FIG. 2 illustrates how a file produced as in FIG. 1 can be filtered to remove visual data, preserving and refining audio data, then processing that data to produce analysis results, according to some embodiments;

FIG. 3 is an exemplary display of a variety of word categories, used to group and quantify the data words, providing insight into a presentation's spoken-word contents, according to some embodiments;

FIG. 4 illustrates how by using input from panels of experts and/or focus groups, one is able to distill a quasi-idealized set of spoken-language metrics against which a presentation's analysis may be weighed, according to some embodiments;

FIG. 5 illustrates how the quasi-idealized model curve can then be used to compare it to a specific presentation's analysis data model, according to some embodiments;

FIG. 6 is an exemplary flow chart showing how the invention system may be used to compute and present its results, according to some embodiments;

FIG. 7 is an exemplary flow chart showing how continuous analysis enriches and improves the idealized model used for comparisons as in FIG. 5, according to some embodiments;

FIG. 8 illustrates a block diagram of a computing system, according to some embodiments; and

FIG. 9 illustrates a block diagram of the computing system and application program, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

Presentations are an important way to convey information to targeted audiences. By their nature, presentations are a combination of body-language, spoken-language, and visual-aid elements. Each contributes to the effectiveness, or lack of effectiveness, in the end product.

For decades there have been tools for capturing and analyzing body-language aspects of presentations. For example, instances of eye contact, use of hand gestures, use of visual aids, body movement, and so on.

Though many of us tend to focus on the body-language aspects of presentations, it is also true that spoken-language aspects have a major impact on presentation effectiveness. For example, speaking too slowly, speaking in a monotone, using too much jargon and acronyms, unvaried cadences are all known to detract from presentation effectiveness.

One can get a qualitative feel for how well a presentation was received by tuning into audience body language. But it is both qualitative and subjective. In order to move towards quantitative analysis and more objective effectiveness conclusions, one must first decide what aspects of spoken-language content need to be identified, isolated, and quantified.

The invention system herein disclosed uses known functional subsystems in a unique way to distill the spoken-language presentation content into predetermined word categories and speech dynamics, such that it becomes possible to capture, quantify and analyze each presentation.

While being able to do the above is most helpful in building up data sets of presentation spoken-language aspects, it still leaves the evaluation of effectiveness as an open issue.

However, if the analyses are coupled with expert panel or focus group findings, one is able to begin refining a model of which spoken-language aspects, to what extent, provide effectiveness improvements. In other words, the invention can be used both to capture and analyze spoken-language aspects of a presentation, and to use those findings in conjunction with complementary scoring by expert panels and focus groups to build a quasi-idealized model of spoken-language aspects as they relate to increased presentation effectiveness.

Clearly, such analysis and modeling is by its very nature somewhat soft science and certainly subject to cultural differences. That said, it can provide much greater insight into how best to improve presentations, within a specific culture, that is far more effective than simply taking a qualitative stab at overall presentation effectiveness improvement. And, as the data sets become more plentiful, the overall aggregate becomes richer helping to better refine the idealized models.

With regard to word categories, filler words are those, such as “like,” or “um,” or “well” that are typically used to fill in rather than being silent. Empathetic words are “you,” “your” and “us,” and words that personalize points being made. Positive words include “good,” “great,” and the like. Slang are words that have taken on a meaning other than their original use such as “cool,” “hip,” “groovy,” and so on. The following is meant to help visualize and understand the invention and a method of use. Persuasive words are ones such as “must,” “have to,” “need” and the like. Profane words are those currently considered impolite. And jargon words and acronyms are those associated with a job such as “perp,” “CPU,” “fab,” and the like. This is a dynamic list that will grow and change, over time, and the word database needs to be dynamic so as to be able to re-associate words with different categories, or assign categories to words heretofore uncategorized, as things change.

The system disclosed could also be used to help define and research additional spoken-language aspects. For example, in addition to capturing all the words during a presentation, the data also can be parsed to show not only average cadence but segments of higher and lower cadence wherein deviations from the average cadence can be calculated and quantified. So, for example, if a speaker varied the cadence significantly to slow down and emphasize certain points and then speed up to transition to another emphatic slow down, the system could capture and process all of this so as to either embellish or define an additional cadence-related aspect.

The digitized audio data is based on the analog-audio electrical signal which contains both frequency and amplitude information. Thus, in addition to grouping words by word categories, these words could also be appended with amplitude metrics that indicate whether the word was softly spoken or emphatically and more loudly spoken. One often hears presentation criticisms such as “he just droned on and on” meaning there was a steady, monotonous flow of words. Or “she spoke in a monotone,” meaning there was little change in inflexion. By capturing variations in cadence and loudness, one can broaden the scope of analysis and experimentation. Here, again, these newly defined aspects may also be compared when expert-panel or focus-group scoring is correlated with cadence and loudness variations. It may turn out that these aspects are less significant that word category choices, but until captured, grouped and analyzed, it would remain speculative rather than more definitive.

The following paragraphs are meant to elucidate the system and methods of its use in terms of structures, functions and steps.

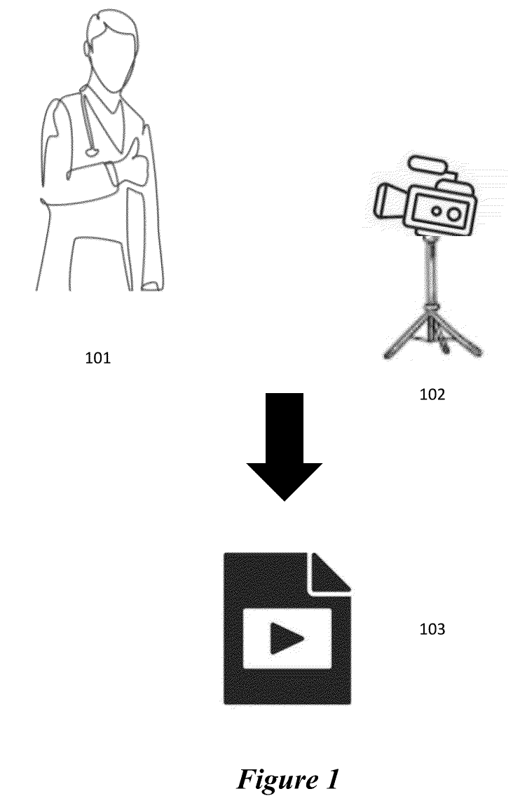

In FIG. 1, a person 101 is giving a presentation which is being captured by a video camera/recorder 102 and ultimately produces a digitized data file of the presentation 103.

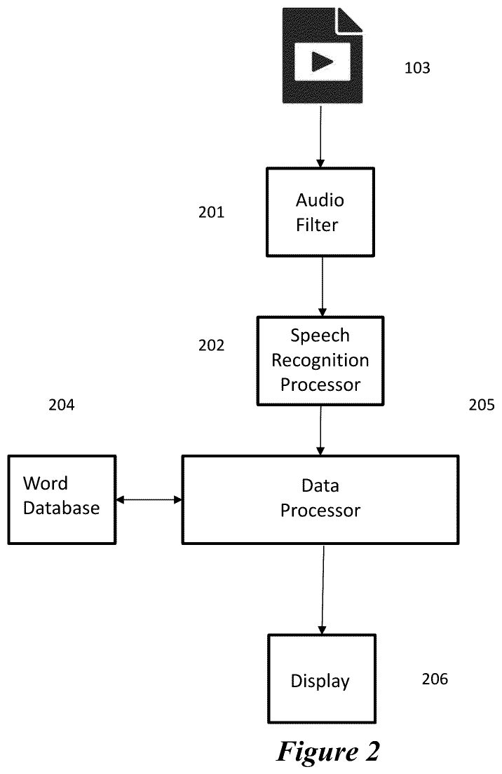

Beginning with the digitized data file of the presentation 103 we see in FIG. 2 that the data file which comprises both visual and spoken digitized data content is first filtered by a filter 201 to preserve only the spoken digitized data, which may be refined by signal processing to reduce or eliminate extraneous data, such as ambient noise. The spoken digitized content passes through a speech-recognition processor 202 such that it is distilled into a set of recognized words. In the data processor 205 the words are compared to those contained in a word database 204 such that they may be grouped by predetermined word categories and quantified. Furthermore, the data processor is programmed to count the total number of words, the total duration, and then calculate the average cadence of the presentation. All these results are then reported and displayed on a display 206.

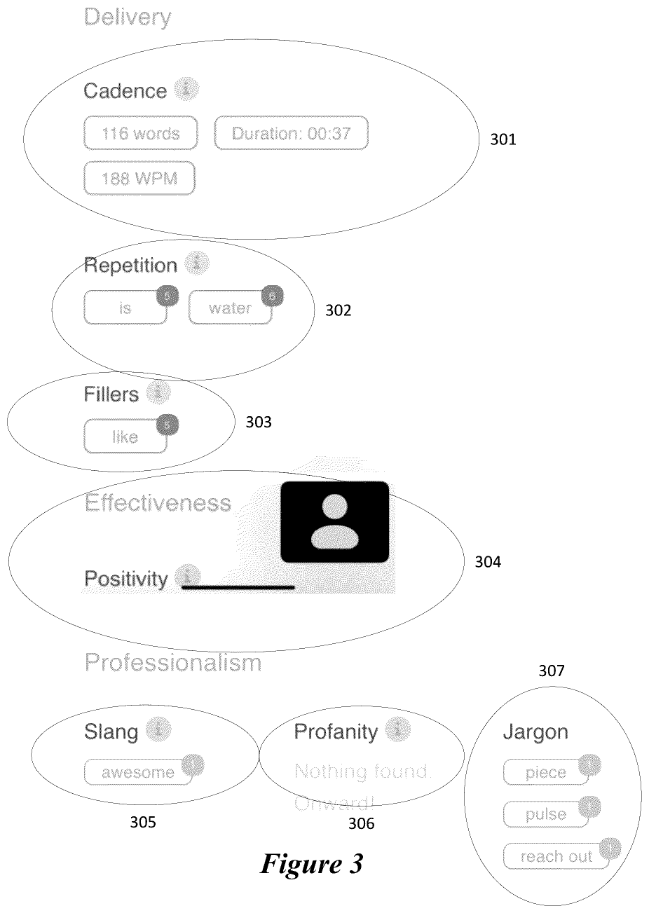

FIG. 3 shows an embodiment of the display results that may have been produced using the invention of FIG. 2. Under the heading of “delivery” the cadence 301 is shown as word number, duration and speed in words-per-minute. The number of repeated words (e.g., “is” and “water”) is shown along with the number of repetitions 302. The number of filler words, such as “like,” or “um,” is shown with number of times they occurred 303. Effectiveness is quantified 304 in terms of positivity. And professionalism is quantified in terms of use of slang 305, profanity 306 and jargon 307.

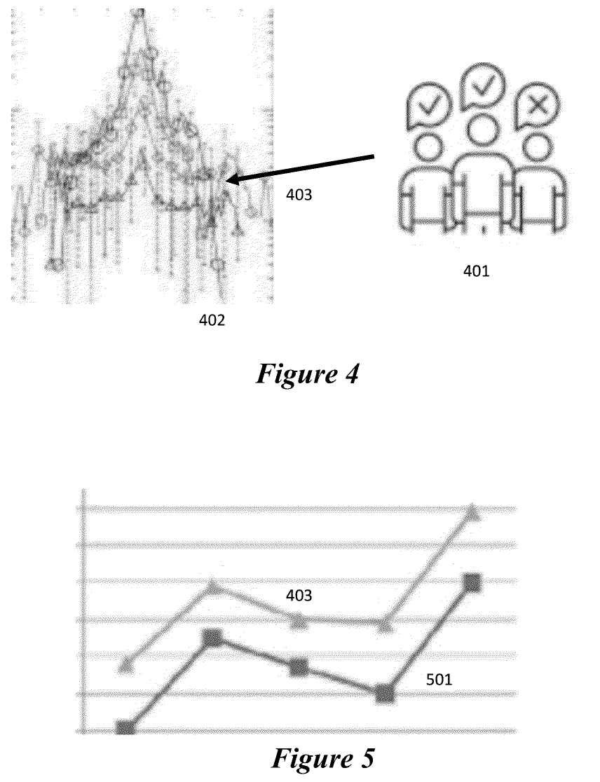

The results as shown in FIG. 3 are quantitative results, but they are not necessarily evaluative by an objective standard. So, as shown in FIG. 4, by using analyses 402 in conjunction with expert panels and/or focus groups 401 it is possible to refine a quasi-idealized model 403 that has been shown to have some consensus of feedback scoring.

As a result, as shown in FIG. 5, the quasi-idealized model 403 may then be used to compare and help evaluate the effectiveness of a presentation's data model 501.

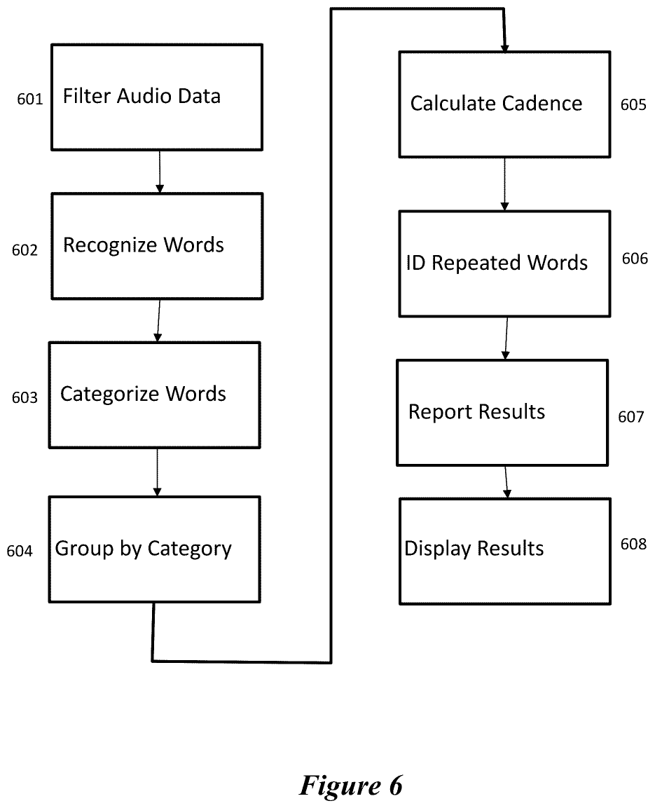

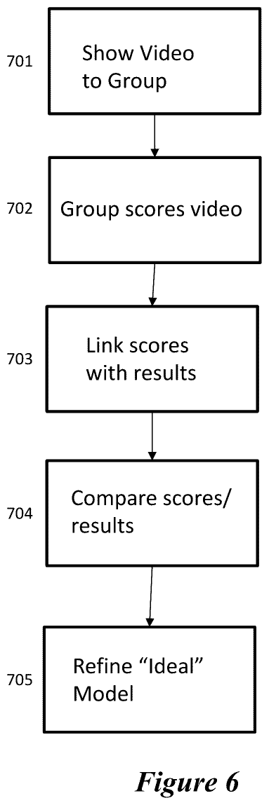

FIG. 6 shows an embodiment flow diagram of method steps, using the invention, that begin with filtering the video's digitized data 601, recognizing words 602, categorizing the words 603, grouping the words by category 604, calculating speech average cadence 605, identifying repeated words and quantifying repetition 606, reporting the results 607, and displaying the results 608.

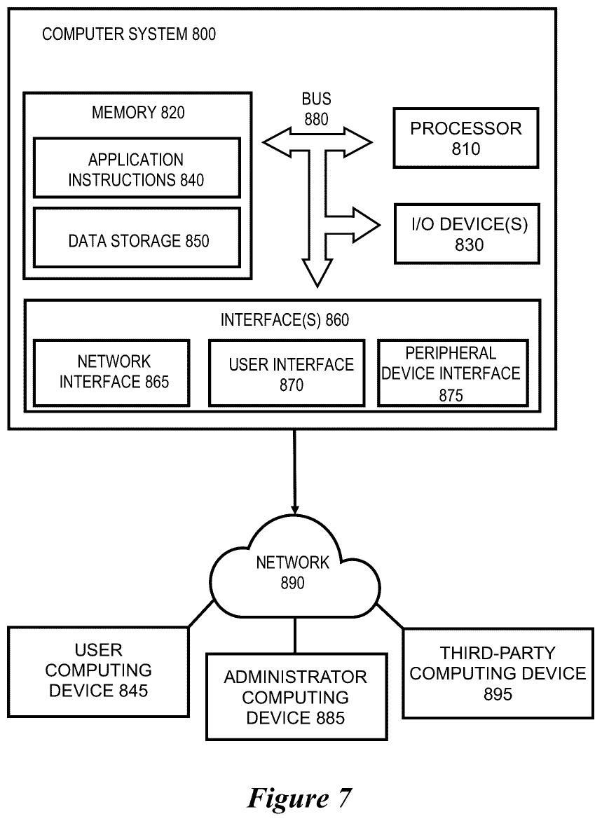

As part of refining a quasi-idealized model for presentation effectiveness, FIG. 7 shows that the video is shown to an expert panel and/or focus group 701, the group's members score the video in predetermined terms 702, the scores are linked with analysis results 703, the scores are compared to analysis results 704 and the quasi-ideal model is further refined 705.

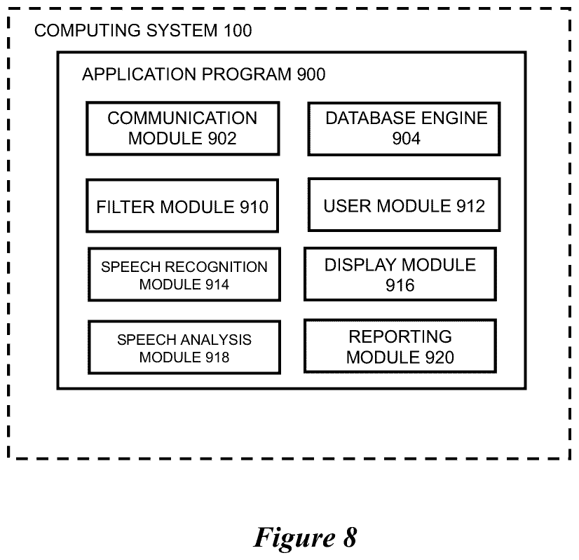

FIG. 8 illustrates an example of a computer system 800 that may be utilized to execute various procedures, including the processes described herein. The computer system 800 comprises a standalone computer or mobile computing device, a mainframe computer system, a workstation, a network computer, a desktop computer, a laptop, or the like. The computing device 800 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 800 includes one or more processors 810 coupled to a memory 820 through a system bus 880 that couples various system components, such as an input/output (I/O) devices 830, to the processors 810. The bus 880 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 800 includes one or more input/output (I/O) devices 830, such as video device(s) (e.g., a camera), audio device(s), and display(s) are in operable communication with the computer system 800. In some embodiments, similar I/O devices 830 may be separate from the computer system 800 and may interact with one or more nodes of the computer system 800 through a wired or wireless connection, such as over a network interface.

Processors 810 suitable for the execution of computer readable program instructions include both general and special purpose microprocessors and any one or more processors of any digital computing device. For example, each processor 810 may be a single processing unit or a number of processing units and may include single or multiple computing units or multiple processing cores. The processor(s) 810 can be implemented as one or more microprocessors, microcomputers, microcontrollers, digital signal processors, central processing units, state machines, logic circuitries, and/or any devices that manipulate signals based on operational instructions. For example, the processor(s) 810 may be one or more hardware processors and/or logic circuits of any suitable type specifically programmed or configured to execute the algorithms and processes described herein. The processor(s) 810 can be configured to fetch and execute computer readable program instructions stored in the computer-readable media, which can program the processor(s) 810 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 820 includes computer-readable application instructions 850, configured to implement certain embodiments described herein, and a database 850, comprising various data accessible by the application instructions 840. In some embodiments, the application instructions 840 include software elements corresponding to one or more of the various embodiments described herein. For example, application instructions 840 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 840 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 810 such that the processor 810 can read information from, and write information to, the storage medium. In the alternative, the storage medium may be integrated into the processor 810. Further, in some embodiments, the processor 810 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 840 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 840 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 840 can be downloaded to a computing/processing device from a computer readable storage medium, or to an external computer or external storage device via a network 890. A network adapter card or network interface in each computing/processing device receives computer readable program instructions from the network and forwards the computer readable application instructions 840 for storage in a computer readable storage medium within the respective computing/processing device.

In some embodiments, the computer system 800 includes one or more interfaces 860 that allow the computer system 800 to interact with other systems, devices, or computing environments. In some embodiments, the computer system 800 comprises a network interface 865 to communicate with a network 890. In some embodiments, the network interface 865 is configured to allow data to be exchanged between the computer system 800 and other devices attached to the network 890, such as other computer systems, or between nodes of the computer system 800. In various embodiments, the network interface 865 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 870 and the peripheral device interface 875.

In some embodiments, the network 890 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 890 can comprise copper transmission cables, optical transmission fibers, wireless transmission, routers, firewalls, switches, gateway computers and/or edge servers. The network 890 can represent a single network or multiple networks. In some embodiments, the network 890 used by the various devices of the computer system 800 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 800 may include a user computing device 845, an administrator computing device 885 and a third-party computing device 895 each in communication via the network 890. The user computing device 845 may be utilized to establish credentials, create a user profile, and otherwise interact with the features of the system. The third-party computing device 895 may be utilized by third parties to receive communications from the user computing device and/or administrative computing device 885.

FIG. 9 illustrates an example computer architecture for the application program 900 operated via the computing system 800. The computer system 800 comprises several modules and engines configured to execute the functionalities of the application program 900, and a database engine 904 configured to facilitate how data is stored and managed in one or more databases. In particular, FIG. 9 is a block diagram showing the modules and engines needed to perform specific tasks within the application program 900.

Referring to FIG. 9, the computing system 800 operating the application program 900 comprises one or more modules having the necessary routines and data structures for performing specific tasks, and one or more engines configured to determine how the platform manages and manipulates data. In some embodiments, the application program 900 comprises one or more of a communication module 902, a database engine 904, a filter module 210, a user module 912, a speech recognition module 914, a display module 916, a speech analysis module 918, and a reporting module 920.

In some embodiments, the communication module 902 is configured for receiving, processing, and transmitting a user command and/or one or more data streams. In such embodiments, the communication module 902 performs communication functions between various devices, including the user computing device 845, the administrator computing device 885, and a third-party computing device 895. In some embodiments, the communication module 202 is configured to allow one or more users of the system, including a third-party, to communicate with one another. In some embodiments, the communications module 902 is configured to maintain one or more communication sessions with one or more servers, the administrative computing device 885, and/or one or more third-party computing device(s) 895. In some embodiments, the communication module 902 allows each user to transmit and receive information which may be used by the system.

In some embodiments, the communication module 902 is in operable communication with the database engine to transmit information stored in the system, stored in third-party databases, or to transmit information input by the user.

In some embodiments, a database engine 904 is configured to facilitate the storage, management, and retrieval of data to and from one or more storage mediums, such as the one or more internal databases described herein. In some embodiments, the database engine 904 is coupled to an external storage system. In some embodiments, the database engine 904 is configured to apply changes to one or more databases. In some embodiments, the database engine 904 comprises a search engine component for searching through thousands of data sources stored in different locations. The database engine 904 allows each user and module associated with the system to transmit and receive information stored in various databases.

In some embodiments, the filter module 910 is in operable communication with the computing system to receive audio and/or digitized video data and filter (i.e., separate) the audio data from the digitized video data content. The filter module 910 provides filtered audio which can be used by the system to analyze the quality of speech provided in a personal presentation. The filter module 910 transmits the filtered audio to the speech recognition module 914 for further processing as described herein.

In some embodiments, the user module 912 facilitates the creation of a user account for the application system. The user module 912 may allow the user to input account information, establish user permissions and the like.

In some embodiments, the speech recognition module 914 is in operable communication with the computing system and receives filtered audio from the filter module 910. The speech recognition module 914, in communication with a speech recognition processor, identifies digitized spoken words based on data representing the digitized spoken words. The data may include categorizations of words which may include any of the following: empathetic words, slang words, jargon, filler words, persuasive words, profane words, positive words, negative words, etc.

In some embodiments, the display module 916 is configured to display one or more graphic user interfaces, including, e.g., one or more user interfaces, one or more consumer interfaces, one or more video presenter interfaces, etc. In some embodiments, the display module 916 is configured to temporarily generate and display various pieces of information in response to one or more commands or operations. The various pieces of information or data generated and displayed may be transiently generated and displayed, and the displayed content in the display module 916 may be refreshed and replaced with different content upon the receipt of different commands or operations in some embodiments. In such embodiments, the various pieces of information generated and displayed in a display module 916 may not be persistently stored. The speech recognition module may also interpret word count, cadence, and other common speech characterizations.

In some embodiments, the speech analysis module 918 is in operable communication with the computing system to analyze speech recognized by the speech recognition module 914. The speech analysis module 918 may analyze the digitized filtered audio to characterize the speech into any of the following: empathetic words, slang words, jargon, filler words, persuasive words, profane words, positive words, negative words, etc.

In some embodiments, the reporting module 920 receives analytical speech data to generate a report as shown and described in FIG. 3. The reporting module 920 provides a useful report to the user to allow the user to track and monitor speech trends over time, as well as view analytics for a single presentation uploaded to the system.

In some embodiments, reporting module 920 can display the values of one or more speech quality metrics. In some embodiments, the speech quality metrics for a conversation can be displayed to a participant (e.g., a sales representative) while the conversation is ongoing. In some embodiments, reporting module 920 can display values derived from one or more speech quality metrics, including, but not limited to, values indicating the differences between the actual and target values of the speech quality metrics. Reporting such values while the conversation is ongoing can motivate the participant to alter his or her speech patterns to improve the values of the quality metrics. In some embodiments the reporting module 920 can guide participant speech by suggesting a change in cadence, frequency of filler words, use of rapport building phrases, script adherence, and/or other measures.

In some embodiments, the plurality of parameters associated with verbal and non-verbal expressions comprises one or more of: pitch, volume, pitch variation, volume variation, frequency of variation of pitch, frequency of volume, frequency of variation in volume, rhythm, tone, speech cadence, frequency of variation of speech cadence, and the cadence of the introduction of new topics and/or introduction of parenthetical topics as extracted by the above and other parameters.

Note that the system depiction is one embodiment. The filter, speech-recognition processor, data processor, database may be implemented in a variety of ways well known in the art. It is the function and organization that is uniquely configured to accomplish the distilling, grouping and reporting as described. Note, also, that the programmed aspects of the data processor may be implemented by one or more programs. Again, it is the distilling, grouping and reporting that is the objective rather than the implementation details, which may vary, and are well known in the art. The drawings are meant to be exemplary and should not be read as limiting the scope or implementation of the invention.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for the analysis of the quality of a personal presentation, the system comprising:
an audio filter operate to separate out digitized audio data content from digitized video data content;
a database of one or more words, one or more word categories, and a plurality of data representing those word;
a speech recognition processor operative to identify one or more digitized spoken words based on the plurality of data representing the one or more digitized spoken words;
a data processing subsystem comprising a central processor, a program memory, and a data memory;
a program, running on the data processing subsystem, operative to control accumulation of a plurality of identified words by the one or more word categories;
the program operative to report a word number by the one or more word categories;
the program operative to control determination of a speech cadence;
the program operative to report the speech cadence;
the program operative to control counting of word repetition; and
a display operative to display one or more reported results of the word number by the one or more word categories, the word repetition, and the speech cadence.

2. The system of claim 1, wherein the one of the one or more word categories is a filler word.

3. The system of claim 1, wherein the one of the one or more word categories is an empathetic word.

4. The system of claim 1, wherein the one of the one or more word categories is a positive word.

5. The system of claim 1, wherein the one of the one or more word categories is a slang word.

6. The system of claim 1, wherein the one of the one or more word categories is a profane word.

7. The system of claim 1, wherein the one of the one or more word categories is a jargon word.

8. The system of claim 1, wherein the one of the one or more word categories is a persuasive word.

9. The system of claim 1, wherein the speech cadence is defined as a number of words divided by a duration of speech.

10. A system for the analysis of the quality of a personal presentation, comprising:
at least one user computing device in operable connection with a network;
an application server in operable communication with the network, the application server configured to host an application program for analyzing speech provided in a personal presentation, the application program having a user interface module for providing access to a report, provided via a report module, through the display module; and
a filter module to filter digitized audio data content from digitized video data content;
a speech recognition module to receive the digitized audio data and to determine and separate the speech from the digitized audio data;
a speech analysis module to analyze the to identify one or more digitized spoken words based on the plurality of data representing the one or more digitized spoken words.

11. The system of claim 10, wherein the word category comprises at least one of the following: filler words, empathetic words, positive words, slang words, persuasive words, profane words, or jargon words.

12. The system of claim 10, wherein the reporting module receives the analytical speech data to generate the report, the report including a listing of recognized words organized in one or more word categories.

13. The system of claim 10, further comprising a communication module to permit the transmission of digitized audio data to a panel of experts or a focus group.

14. The system of claim 10, further comprising a program, running on the data processing subsystem, operative to control accumulation of a plurality of identified words by the one or more word categories;
the program operative to report a word number by the one or more word categories;
the program operative to control determination of a speech cadence;
the program operative to report the speech cadence;
the program operative to control counting of word repetition; and
a display operative to display one or more reported results of the word number by the one or more word categories, the word repetition, and the speech cadence.

15. A method for analyzing the quality of a personal presentation, the method comprising the steps of:
receiving data in a video-data file comprising digitized audio data and digitized video data;
filtering the data in the video-data file to capture only the digitized audio data;
passing the digitized audio data through a speech-recognition processor;
recognizing by the speech-recognition processor each of digitized audio words;
comparing the recognized word against a database of words and their categories;
grouping the recognized word by its associated category;
counting the number of words comprising the video-data file;
determining elapsed time of the video-data file;
calculating speech cadence by dividing the number of words by the elapsed time;
accumulating a count for each word occurrence;
reporting each word where the count of occurrence is greater than one;
reporting the count per each repeated word;
reporting the occurrence of word by category; and
displaying each count for total of words by category, by number of words and by duration.

16. The method as in claim 15 further comprising:
aggregating results of the speech cadence, repeated words, and number of words per category in subsequent videos for comparison and analysis.

17. The method claim as in claim 15, further comprising:
playing more than one video before a panel of experts or a focus group;
scoring, by the panel or experts or the focus group, of each of the more than one videos in terms of effectiveness and professionalism;
comparing scores against reported results to create an idealized model; and
using the idealized model to evaluate the effectiveness and professionalism of subsequent videos.

18. The method claim as in claim 16, further comprising:
repeating comparisons of analysis results against scores provided by the panel of experts or the focus groups; and
expanding the comparison of the scores against the analysis results to further refine the idealized model.

19. The method as in claim 15, wherein the word category comprises at least one of the following: filler words, empathetic words, positive words, slang words, persuasive words, profane words, or jargon words.
